(19) United States
(12) Patent Application Publication
(10) Pub. No.: US 2008/0131233 A1
(43) Pub. Date: Jun. 5, 2008

(54) Plate-shaped fastener device

(76) Inventor: Chun I. Yao, Taichung (TW)

Correspondence Address: CHARLES E. BAXLEY, ESQ., 90 JOHN STREET, THIRD FLOOR, NEW YORK, NY, 10038, US

(21) Appl. No.: 12/012,170

(22) Filed: Jan. 30, 2008

Related U.S. Application Data
(63) Continuation-in-part of application No. 11/582,004, filed on Oct. 17, 2006.

(51) Int. Cl. F16B 15/06

(52) U.S. Cl. 411/456

(57) ABSTRACT

A fastener device includes a fastener member having a planar element and having a tip for engaging into a plasterboard, and one or more teeth formed on the planar element for engaging with the plasterboard, a cutting member disposed between the planar element and the tip, one or more reinforcing ribs extended from the planar element for reinforcing the planar element, and a head secured on top of the planar element for being engaged with driving tools and for limiting the engagement of the fastener member into the plasterboard. The fastener member may include one or more ratchet projections extended from the planar element.

The present invention is a continuation-in-part of U.S. patent application Ser. No. 11/582,004, filed 17 Oct. 2006, pending.

### BACKGROUND OF THE INVENTION

1. Field of the Invention

The present invention relates to a plate-shaped fastener device, and more particularly to a plate-shaped fastener device for engaging with the plasterboards and for attaching or securing plasterboards together or for attaching or securing plasterboards to the other supporting objects or walls and for preventing the fastener device from being disengaged from the plasterboards and/or the supporting objects or walls.

2. Description of the Prior Art

Typical plasterboards have been developed and provided for building construction purposes, and the plasterboards are required to be secured together or required to be secured to the other supporting objects or walls with various kinds of fastener devices or fastener strips or the like.

For example, U.S. Pat. No. 5,522,687 to Chen, and U.S. Pat. No. 5,544,746 to Dohi disclose two of the typical fastener bands or belts comprising an elongated holding strop for holding or supporting a number of fasteners or nails.

When the plasterboards are fastened or secured together or secured to the other supporting objects or walls with such kinds of fasteners or nails, the fasteners or nails may have a good chance to be disengaged from the plasterboards and/or the supporting objects or walls, and the plasterboards may have a good chance to be broken by the fasteners or nails.

U.S. Pat. No. 6,196,506 to Wakai discloses another typical plate-shaped fastener for securing a member or instrument to a wall of plasterboard, and comprising a driving portion having a pointed tip. However, typical plate-shaped fasteners may not be driven or hammered with driving tools and may not be attached to or supported on a fastener band or belt.

The present invention has arisen to mitigate and/or obviate the afore-described disadvantages of the conventional fastener devices for plasterboards.

### SUMMARY OF THE INVENTION

The primary objective of the present invention is to provide a plate-shaped fastener device for engaging with the plasterboards and for attaching or securing plasterboards together or for attaching or securing plasterboards to the other supporting objects or walls and for preventing the fastener device from being disengaged from the plasterboards and/or the supporting objects or walls and for preventing the plasterboards from being broken by the fastener device.

In accordance with one aspect of the invention, there is provided a fastener device comprising a fastener member including a planar element having a tip extended from a lower portion thereof, and including a cutting member provided between the planar element and the tip, the cutting member including at least one cutting edge provided therein, the fastener member including a plurality of teeth extended from side portions of the planar element for anchoring purposes, and a head secured to top of the planar element and perpendicular to the planar element.

The fastener member includes an extension extended upwardly from the planar element, and the head includes a slot formed therein for receiving the extension, and the extension is riveted to engage with the head in order to secure the head to the planar element. The teeth may be the ratchet teeth or the like.

The fastener member includes at least one first reinforcing rib extended from the planar element for reinforcing the planar element. The fastener member includes at least one second reinforcing rib extended from the planar element and extended opposite to the first reinforcing rib for further reinforcing the planar element.

The fastener member includes at least one projection extended from the planar element. The projection of the planar element is preferably a ratchet projection.

The cutting member may include a wider upper portion adjacent the planar element and may include a narrower lower portion adjacent the tip of the planar element.

The head of the planar element may include an upwardly curved structure, a downwardly curved structure, or a planar structure or the like.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of one of the fastener members of a fastener device in accordance with the present invention;

FIG. 2 is another perspective view similar to FIG. 1 illustrating the other arrangement of the fastener member;

FIG. 3 is a further perspective view similar to FIGS. 1 and 2 illustrating the further arrangement of the fastener member;

FIG. 4 is a further perspective view similar to FIGS. 1-3 illustrating the still further arrangement of the fastener member;

FIG. 5 is a further perspective view similar to FIGS. 1-4 illustrating the still further arrangement of the fastener member;

FIG. 6 is a further perspective view similar to FIGS. 1-5 illustrating the still further arrangement of the fastener member;

FIG. 7 is a further perspective view similar to FIGS. 1-6 illustrating the still further arrangement of the fastener member;

FIG. 8 is a further perspective view similar to FIGS. 1-7 illustrating the still further arrangement of the fastener member;

FIG. 9 is a further perspective view similar to FIGS. 1-8 illustrating the still further arrangement of the fastener member;

FIG. 10 is a further perspective view similar to FIGS. 1-9 illustrating the still further arrangement of the fastener member;

FIG. 11 is a cross sectional view of the fastener member taken along lines 11-11 of FIG. 10;

FIG. 12 is a further perspective view similar to FIGS. 1-10 illustrating the still further arrangement of the fastener member;

FIG. 13 is a cross sectional view of the fastener member taken along lines 13-13 of FIG. 12;

FIG. 14 is a further perspective view similar to FIGS. 1-10 and 12 illustrating the still further arrangement of the fastener member; and

FIG. 15 is a cross sectional view of the fastener member taken along lines 15-15 of FIG. 14.

### DETAILED DESCRIPTION OF THE PREFERRED EMBODIMENT

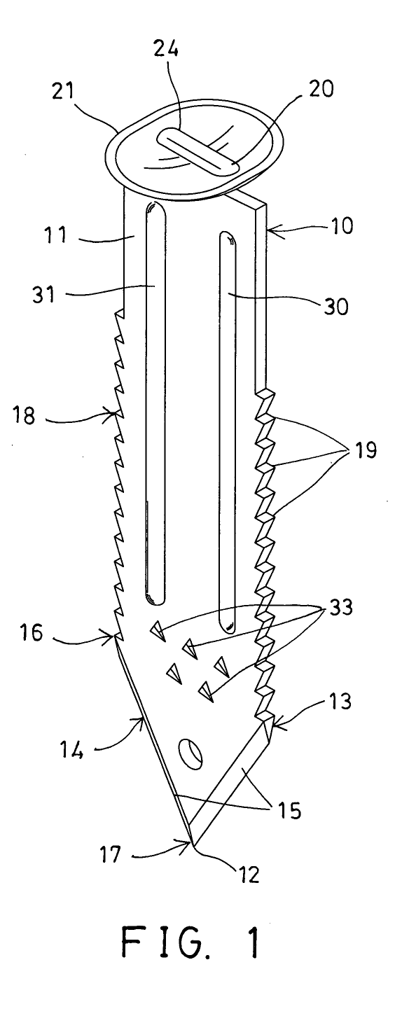

Referring to the drawings, and initially to FIG. 1, a fastener device in accordance with the present invention comprises a number of fastener members 10 held or supported together with one or more holding or supporting strips (not shown). However, the attachment or the securing of the fastener members 10 to the holding or supporting strips is not related to the present invention and will not be described in further details. One example of the attachment or the securing of the fastener members 10 to the holding or supporting strips has been disclosed in the copending U.S. patent application Ser. No. 11/582,004, filed 17 Oct. 2006, which may be taken as a reference for the present invention.

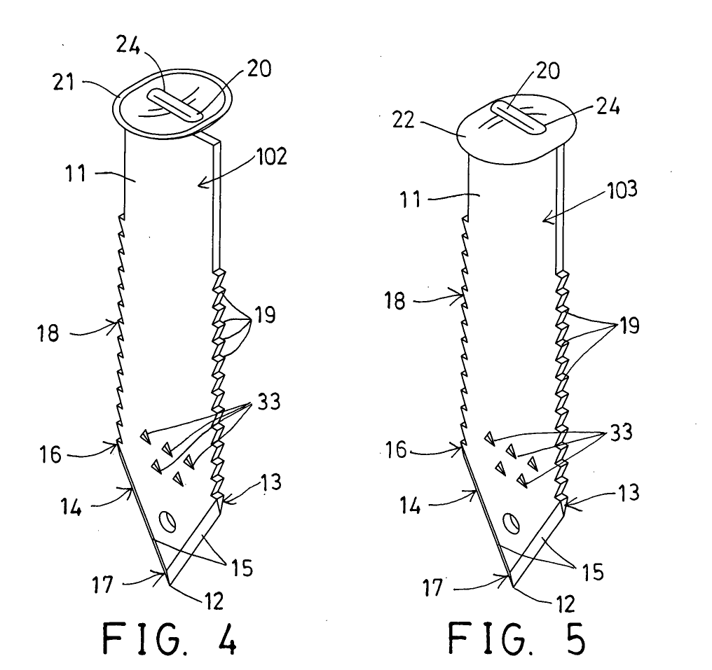

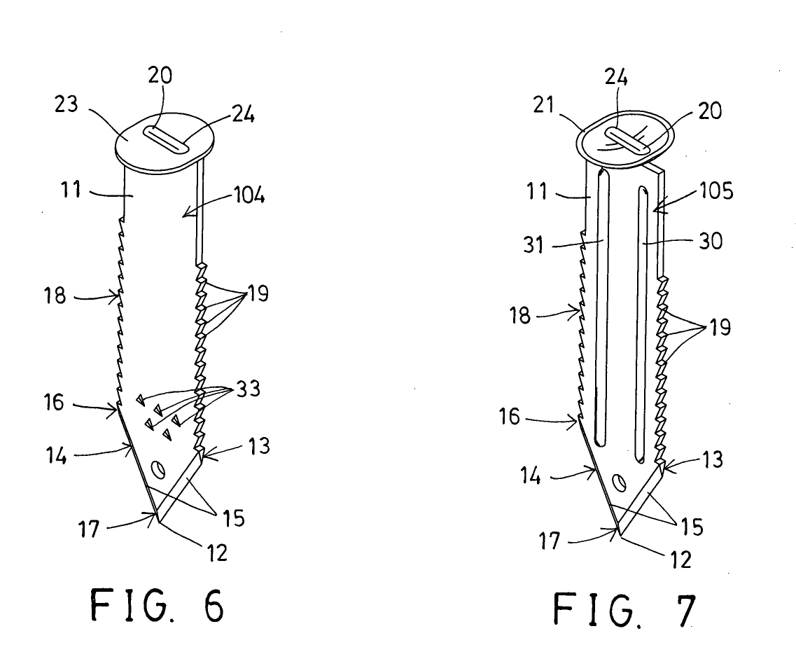

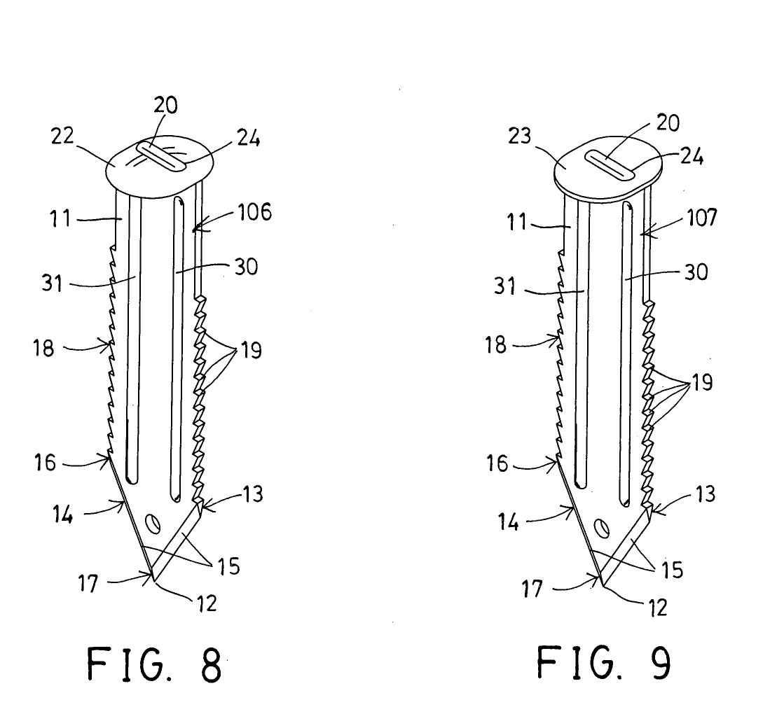

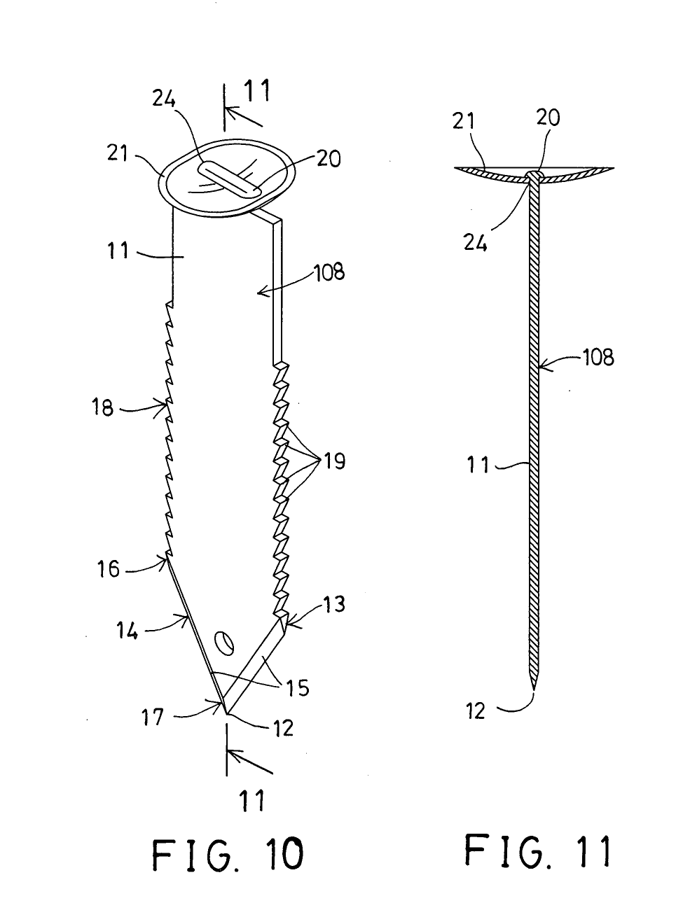

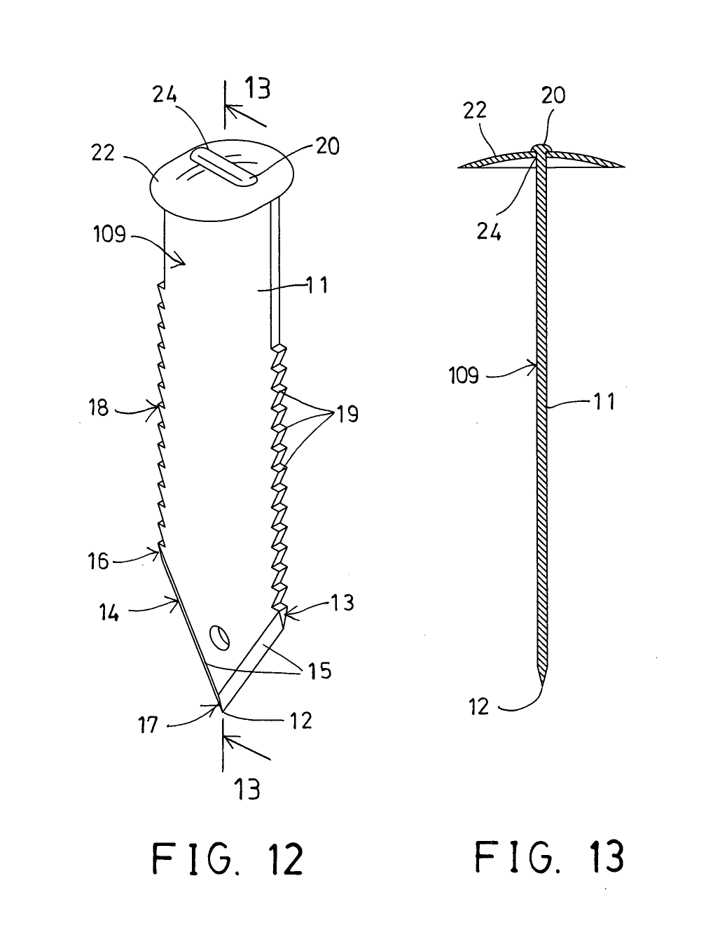

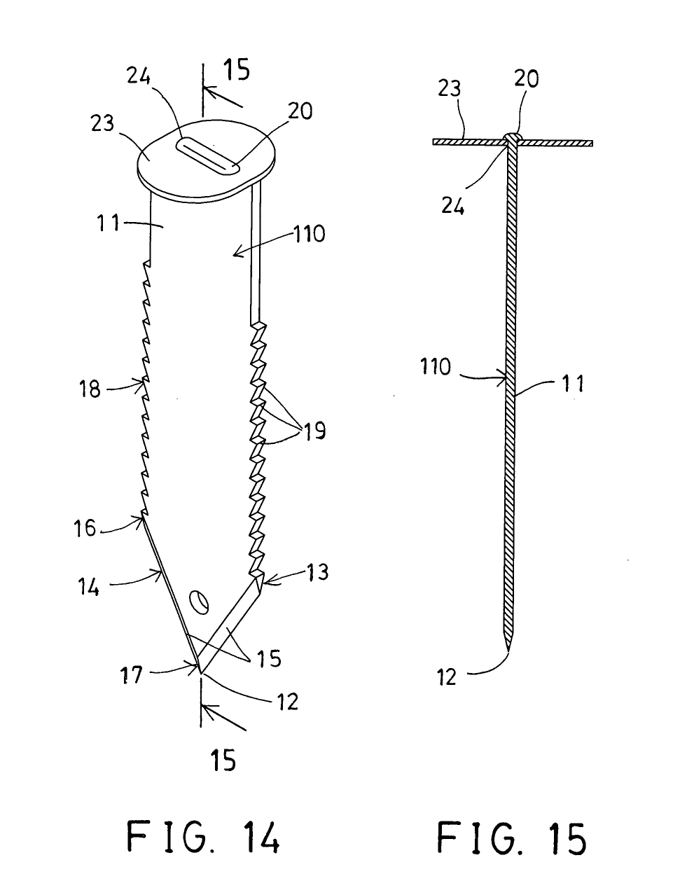

As shown in FIGS. 1-10, 12 and 14, the fastener members 10, 100-110 each include a planar body or plate or element 11 having a tip 12 extended from the lower portion 13 thereof for easily engaging into one or more plasterboards (not shown) for attaching or securing the plasterboards together or for attaching or securing the plasterboards to the other supporting objects or walls (not shown), and for preventing the plasterboards from being broken by the fastener members 10, 100-110 of the fastener device. The fastener members 10, 100-110 each further includes a cutting portion or member 14 formed or provided in the lower portion 13 thereof and located between the planar element 11 and the tip 12 of the fastener member 10, 100-110.

The cutting member 14 includes one or more cutting edges 15 formed or provided therein for further facilitating the engagement of the fastener members 10, 100-110 into the plasterboards, and for further preventing the plasterboards from being broken by the fastener members 10, 100-110 of the fastener device. It is preferable that the cutting member 14 of the fastener member 10, 100-110 includes a wider upper portion 16 adjacent or abutting the fastener member 10 or located closer to the fastener member 10, 100-110, and includes a narrower lower portion 17 adjacent or abutting the tip 12 or located closer to the tip 12 for allowing the cutting member 14 of the fastener member 10, 100-110 to be formed as a triangular shape or wedge-shape and for further facilitating the engagement of the fastener members 10, 100-110 into or through the plasterboards.

The fastener member 10, 100-110 further includes an anchoring means or device 18 formed or provided on the side portion thereof and having one or more teeth 19, such as ratchet teeth 19 provided on or extended from the side portion of the fastener member 10, 100-110 for engaging with the plasterboards after the fastener member 10, 100-110 has been engaged into or through the plasterboards, and thus for anchoring or securing the fastener member 10, 100-110 to the plasterboards and for preventing the fastener member 10, 100-110 from being disengaged from the plasterboards. The fastener member 10, 100-110 further includes a rivet or extension 20 extended upwardly from the planar element 11 and having a width equals to that of the planar element 11 of the fastener member 10, 100-110, and having a length smaller than that of the planar element 11 of the fastener member 10, 100-110 for riveting or attaching or securing a head 21, 22, 23 to the planar element 11 of the fastener member 10, 100-110. The heads 21-23 are preferably arranged perpendicular to the planar element 11 of the fastener members 10, 100-110 for engaging with the plasterboards and for limiting the movement or the engagement of the fastener members 10, 100-110 into or through the plasterboards and for preventing the fastener member 10, 100-110 from being completely engaged into or through the plasterboards.

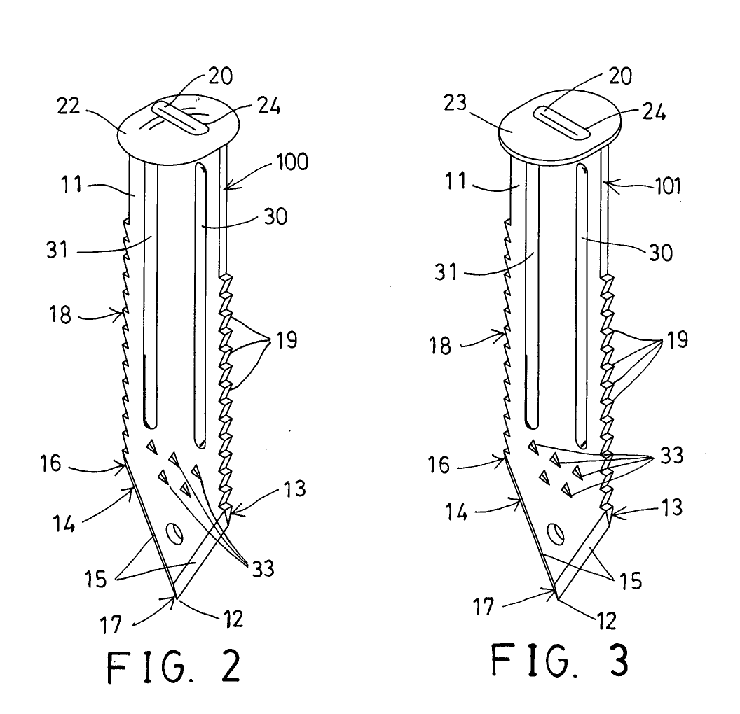

For example, the heads 21-23 of the fastener members 10, 100-110 each include a slot 24 formed therein for receiving or engaging with the extension 20, and the extension 20 may then be hammered or forged or riveted to engage with the heads 21-23 (FIGS. 11, 13, 15) in order to solidly attach or secure the heads 21-23 to the fastener member 10, 100-110. The heads 21-23 of the fastener members 10, 100-110 may include a recessed or upwardly curved structure (FIGS. 1, 4, 7, 10-11), or a downwardly curved structure (FIGS. 2, 5, 8, 12-13), or a flat or planar structure (FIGS. 3, 6, 9, 14-15), and the heads 21-23 are arranged for such as centering purposes, or for facilitating the driving or the engagement of the fastener members 10, 100-110 into or through the plasterboards, or for allowing the fastener member 10, 100-110 to be easily driven or hammered by the driving tools (not shown).

As shown in FIGS. 1-3, 7-9, the fastener member 10, 100-101, and 105-107 may further include one or more reinforcing protrusions or ribs 30 extended from one side thereof for forming a recess in the other side or the opposite side thereof, and/or one or more further reinforcing protrusions or ribs 31 extended from the other side or the opposite side thereof for forming a recess in the one side thereof, and for reinforcing the fastener member 10, 100-101, and 105-107 and for preventing the fastener member 10, 100-101, and 105-107 from being easily bent or distorted, and also for allowing the fastener member 10, 100-101, and 105-107 to be effectively driven or engaged into or through the plasterboards. As shown in FIGS. 1-6, the fastener member 10, 100-104 each may further include one or more ratchet teeth or projections 33 extended from either of the sides of the planar element 11 for further engaging with the plasterboards and for further preventing the fastener member 10, 100-104 from being disengaged from the plasterboards.

It is to be noted that the provision of the tip 12 and/or the cutting member 14 allows the fastener member 10, 100-110 to be easily driven or hammered into or through the plasterboards by the driving tools and may prevent the plasterboards from being broken by the fastener device. The anchoring means or device 18 of the fastener member 10, 100-110 may anchor or secure the fastener member 10, 100-110 to the plasterboards and may prevent the fastener member 10, 100-110 from being disengaged from the plasterboards. The reinforcing protrusions or ribs 30, 31 may prevent the fastener member 10, 100-101, and 105-107 from being easily bent or distorted. The ratchet projections 33 of the fastener members 10, 100-104 may further anchor or secure the fastener members 10, 100-104 to the plasterboards and may prevent the fastener member 10, 100-104 from being disengaged from the plasterboards.

Accordingly, the fastener device in accordance with the present invention includes a plate-shaped fastener device for engaging with the plasterboards and for attaching or securing plasterboards together or for attaching or securing plasterboards to the other supporting objects or walls and for preventing the fastener device from being disengaged from the plasterboards and/or the supporting objects or walls and for preventing the plasterboards from being broken by the fastener device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener device comprising:
a fastener member including a planar element having a tip extended from a lower portion thereof, and including a cutting member provided between said planar element and said tip,
said cutting member including at least one cutting edge provided therein,
said fastener member including a plurality of teeth extended from side portions of said planar element for anchoring purposes, and
a head secured to top of said planar element and perpendicular to said planar element.

2. The fastener device as claimed in claim 1, wherein said fastener member includes an extension extended upwardly from said planar element, and said head includes a slot formed therein for receiving said extension, and said extension is riveted to engage with said head in order to secure said head to said planar element.

3. The fastener device as claimed in claim 1, wherein said teeth are ratchet teeth.

4. The fastener device as claimed in claim 1, wherein said fastener member includes at least one first reinforcing rib extended from said planar element for reinforcing said planar element.

5. The fastener device as claimed in claim 4, wherein said fastener member includes at least one second reinforcing rib extended from said planar element for further reinforcing said planar element.

6. The fastener device as claimed in claim 5, wherein said at least one second reinforcing rib is extended opposite to said at least one first reinforcing rib.

7. The fastener device as claimed in claim 1, wherein said fastener member includes at least one projection extended from said planar element.

8. The fastener device as claimed in claim 7, wherein said at least one projection of said planar element is a ratchet projection.

9. The fastener device as claimed in claim 1, wherein said cutting member includes a wider upper portion adjacent said planar element and includes a narrower lower portion adjacent said tip of said planar element.

10. The fastener device as claimed in claim 1, wherein said head of said planar element includes an upwardly curved structure.

11. The fastener device as claimed in claim 1, wherein said head of said planar element includes a downwardly curved structure.

12. The fastener device as claimed in claim 1, wherein said head of said planar element includes a planar structure.
